(19) United States
(12) Patent Application Publication
(10) Pub. No.: US 2025/0223445 A1
(43) Pub. Date: Jul. 10, 2025

(54) HYBRID STRUCTURAL POLYMER-BINDER COMPOSITE CONSTRUCTION AND PAVING MATERIAL

(71) Applicant: New Village Initiative LLC, Orlando, FL (US)

(72) Inventors: Gary Beeman, Park Rapids, MN (US); Andrew T. LaCroix, St. Louis, MO (US); Donald Russell, Oakland, FL (US); Michael Yonker, Waukee, IA (US); Mark D. Beeman, Sandpoint, ID (US)

(73) Assignee: New Village Initiative LLC, Orlando, FL (US)

(21) Appl. No.: 19/088,758

(22) Filed: Mar. 24, 2025

Related U.S. Application Data
(63) Continuation-in-part of application No. 17/463,454, filed on Aug. 31, 2021, now Pat. No. 12,258,293.
(60) Provisional application No. 63/072,303, filed on Aug. 31, 2020.

(51) Int. Cl. C08L 95/00; C04B 14/02; C04B 14/28; C04B 16/04; C04B 28/04; C08K 3/04; C08K 3/22; C08K 3/26

(52) U.S. Cl. CPC C08L 95/00; C04B 14/026; C04B 14/28; C04B 16/04; C04B 28/04; C08K 3/041; C08K 3/042; C08K 3/22; C08K 3/26; C08K 2003/2206; C08K 2003/265; C08K 2201/003; C08K 2201/004; C08L 2555/22; C08L 2555/24; C08L 2555/34; C08L 2555/52

(57) ABSTRACT

A hybrid additive for use in construction materials such as asphalt and concrete. The additive includes a plastic or polymer material, and one or more of fibers, pozzolans, nano-carbon tubes, glass, recycled asphalt shingles (RAS), liquid anti-strip, hydrated lime, rejuvenators, cementitious material, and ground tire rubber. Also disclosed are hybrid composite materials useful as paving and building materials, and methods of making the same. The hybrid additives were found to improve the performance of the asphalt and concrete mixtures by increasing bonding and strength within the mixture, thereby lowering the costs and increasing the performance and useable life of structures formed using the mixtures.

### CROSS-REFERENCE TO RELATED APPLICATIONS

This application is a continuation-in-part application of U.S. patent application Ser. No. 17/463,454, filed Aug. 31, 2021, now U.S. Pat. No. 12,258,293, which claims priority to U.S. Provisional Application Ser. No. 63/072,303, filed Aug. 31, 2020, both of which are incorporated herein by reference in their entirety.

### FIELD OF THE INVENTION

The invention relates generally to construction and paving materials, and more specifically to a hybrid additive comprising a plastic or polymeric material and one or more additives.

### BACKGROUND

The limitations of construction materials are typically related to factors such as strength, durability, and cost-effectiveness. Currently, various solutions have been developed to enhance these characteristics in both construction and pavement materials.

Some of these solutions attempt to increase the adhesion and cohesion of construction composites. These solutions often fail to meet the needs of the industry because they fail to address inconsistencies of materials, e.g., cementitious materials, aggregate, and additives, which cause poor bonding in the construction materials, such as concrete or asphalt mixtures. For instance, in the paving industry, asphalt binders are frequently modified using elastomeric polymers, such as styrene-butadiene-styrene (SBS) and styrene butadiene rubber (SBR), and plastomers, such as polypropylene (PP) and polystyrene (PS). However, issues such as compatibility, storage stability, and variability in performance arise when these polymers are incorporated using wet processes in asphalt binders. These concerns include fluctuations in quality, temperature-related performance changes, separation, and mixing challenges. Similarly, in the building industry, cement mixtures are often modified with fly ash, but its performance can vary significantly depending on the source, further complicating consistency and reliability.

Furthermore, asphalt binders are refined products of crude oils. Since crude oils are traded globally, their composition can vary significantly on a daily basis, depending on the specific crude oil source used by a given refinery. In addition, refineries extract other products, such as gasoline, heating oil, lubricants, etc., from the crude oil, which can vary depending on seasonal needs and will further change the composition of asphalt binders. Therefore, asphalt binder performance with a given aggregate can varying greatly depending on the refining operations.

Likewise, aggregates can affect the performance of cementitious construction materials. The properties of aggregates can vary greatly depending upon the source of the material, such as natural or quarried aggregate, the number and quality of crushed faces on the aggregate, which affects the internal friction, and the response of aggregates to different chemical processes, such as products of internal hydration or inorganic salts applied to the surface. Furthermore, aggregates are typically limited to local materials to reduce shipping costs, and changing aggregate sources is difficult. Thus, contractors must work with the variability of the available materials.

Another reason solutions aimed at enhancing adhesion and cohesion often fall short in meeting the needs of the construction materials industry is that these solutions typically serve as optimizations, requiring precise dosing. Deviations from the optimal dosage can lead to weaker bonding in composite construction materials. Furthermore, some of these solutions are designed for specific types of aggregates, such as granite, limestone, or basalt, which have either positive or negative surface charges, making them unsuitable for use with a wide variety of aggregate types.

Still, other solutions seek to strengthen construction materials to reduce deformation and increase the structural coefficient of the material in a structure, such as pavements or building walls and columns. However, these solutions also fail to meet industry needs due to difficulties in producing the composite mixture. For example, some solutions, such as fiber additives, require specialized equipment for proper incorporation of the additive into the production process. Some solutions do not disperse well within the mixture. Furthermore, some solutions involve complex and cumbersome processes that demand significant space and resources at production facilities.

Still, other solutions seek to increase the ability to include recycled aggregate materials, such as recycled or reclaimed asphalt pavement, recycled asphalt shingles, and recycled concrete, into construction composites. These solutions also fail to meet industry needs because they reduce the strength of the mixture due to poor bonding between the recycled aggregate materials and virgin components to the point that excessive structural deflections occur, and thereby cracking or the solutions increase the brittleness of the mixture, which decreases the cracking resistance of the mixture. Furthermore, these solutions do not address the inconsistencies of recycled aggregate materials.

Recycled aggregate materials have similar inconsistencies as aggregate material, including source and quality of material. In addition, recycled aggregate materials are stockpiled like aggregates, which means that it can contain moisture due to exposure to rain and humidity. These inconsistencies have created natural limits to the amount of recycled aggregate materials that can be used in composite construction mixtures, such as asphalt mixtures and concrete mixtures, due to quality control issues.

Similar issues exist in other construction materials, such as cement, concrete, plasters, mortars, and dimensional lumber replacements.

Accordingly, it would be desirable to provide construction materials with any one or more of: greater consistency in resistance to deformation, denting, cracking, and/or moisture over the temperature range that construction materials experience for a variety of different aggregates and/or other base materials.

Also desirable would be construction materials with greater consistency in workability over the range of environmental conditions, such as temperature, moisture, wind, and solar radiance, during application such as pavements or vertical structures such as houses. As an example, typical additives to an asphalt paving mixture to improve rutting resistance include stiffer binders at elevated temperatures, higher quality aggregates, and fibers, such as cellulose and aramid fibers. Typical additives that may improve moisture resistance include liquid anti-strip additives and hydrated lime. Additives that improve rutting resistance do not consistently improve moisture resistance, and vice versa. In vertical construction, workability of cementitious mixtures is necessary for moving and forming the material into desired forms, so additional water or plasticizers are added to the concrete mixture to increase workability. Depending on the environmental conditions of humidity and temperature, the workability will vary for a given dosage, and frequently a trade-off for improved workability is ultimate strength, which is undesirable for the final product.

Furthermore, it would be desirable to have a composite construction material that is easy to manufacture at a production plant. For example, additives, such as hydrated lime and fibers, require cumbersome procedures or special equipment to implement at asphalt and concrete plants.

Still further, it would be desirable to have a composite construction material that incorporates higher contents of recycled aggregate materials and other recycled construction materials, such as recycled glass and wood. The use of these materials offers significant environmental benefits, as they help recycle materials that are difficult to dispose of and reduce the need to mine or harvest virgin materials, which may be in limited supply. This approach enhances the sustainability of the composite construction material. Recycled aggregate materials provide strong economic advantages by lowering the cost of aggregates compared to virgin materials. Recycled concrete reduces the need for new aggregates and the expense of disposing of old concrete. Additionally, recycled asphalt pavement and recycled asphalt shingles offer the added benefit of asphalt binder, which can be reused in new asphalt mixtures, reducing the need for virgin asphalt binder. However, prior art has limited the use of these recycled materials to less than 20% of the total volume in asphalt binder mixtures due to inconsistencies in the materials, such as variations in gradation and moisture content.

Usage of these materials has a strong benefit of recycling materials that are difficult to dispose and reduces requirements to mine, harvest, or source virgin materials, which may be in limited supply, thereby increasing the sustainability of the composite construction material. Recycled aggregate materials provide strong economic benefits due to decreased cost of the aggregate materials instead of virgin materials. Recycled concrete reduces the need for virgin aggregates and the expense of disposing of old concrete. Reclaimed asphalt pavement and recycled asphalt shingles offer the additional benefit of including asphalt binder, which can be utilized in an asphalt mixture to reduce the amount of virgin or new asphalt binder required for the mixture. Prior art utilization of these recycled materials has been limited to a low percentage of total volume, typically less than 20% of the total asphalt binder mixture, due to the inconsistencies, e.g., gradation and moisture, of these materials.

### SUMMARY

The disclosed inventions advantageously fill these needs and address the aforementioned deficiencies by providing an additive for construction materials that increases bonding between aggregate, cementitious materials, and recycled aggregate materials (RAM) without requiring complex processes to incorporate desirable structural polymers into the construction mixture. Moreover, the disclosed invention further provides novel composite construction materials comprising the additive, and methods for making the additive and the composite construction materials comprising the additive.

Accordingly, the present disclosure relates to hybrid additives for use in construction materials. The hybrid additives generally comprise a plastic or polymeric material, and one or more additional materials. In certain implementations, the hybrid additive may comprise 95 wt. % to 99.9 wt. % of the plastic or polymeric material and 0.1 wt. % to 5 wt. % of the additional materials.

The plastic or polymeric material of the pellets may be recycled or virgin materials. Exemplary plastic or polymeric materials comprise one or more of high-density polyethylene (HDPE), low-density polyethylene (LDPE), polypropylene, polystyrene, polytetrafluoroethylene in compacted, heat-treated, or gas-expanded form.

The one or more additional materials may be fibers, pozzolans, nano-carbon tubes, glass, recycled asphalt shingles (RAS), liquid anti-strip, hydrated lime, graphene, calcium carbonate, rejuvenators, cementitious material, and ground tire rubber, hydrated lime, graphene, and pozzolanic materials. These additional materials may be incorporated into the hybrid additive. Certain of these additional materials may also be coated on a surface of the hybrid additive. For example, according to certain aspects, the hybrid additive may be coated with a cementitious material that includes calcium carbonate and pozzolanic materials.

The hybrid additive may be formed as pellets. The pellets may have a length of 3 to 13 mm, a diameter of 1 to 13 mm, and an end curvature of 1° to 30° measured as a total deflection from a longitudinal axis thereof. Furthermore, the pellets may be formed using a plastic or polymeric material that has a specific melting temperature or range of melting temperatures depending on the final end use thereof, such as a melting temperature of 95° C. to 140° C. when used in asphalt mixtures. Exemplary pellets may comprise dimples, indentations, or inclusions on a surface of the pellet that contain the additional materials, such as a cementitious material.

The hybrid additive may be formed to have a substantially spherical shape having a nominal diameter of 1.0 mm to 20 mm, such as 1.6 mm to 13 mm.

The hybrid additive may be formed as an aggregate, e.g., material that includes one or more vertices, having diameters of from 2 mm to 75 mm, such as from 2 mm to 50 mm, or from 2 mm to 20 mm.

The hybrid additive may be formed as a sand, i.e., material that includes one or more vertices, having diameters of from 0.02 mm to 2 mm, such as from 0.02 mm to 0.125 mm, or from 0.125 mm to 0.25 mm, or from 0.25 mm to 0.5 mm, or from 0.5 mm to 2.0 mm.

The present disclosure further relates to hybrid construction materials. The hybrid construction materials may be configured as asphalt-based materials, as cementitious materials, or the like. The hybrid construction materials may include a binder, an aggregate, and a hybrid additive. The hybrid construction material.

According to certain aspects, when the hybrid construction material is configured as an asphalt-based construction material, it may comprise 0.5 wt. % to 15 wt. % of an asphalt binder, 0.1 wt. % to 10 wt. % of the hybrid additive, and an aggregate, wherein the wt. % is based on a total weight of the hybrid construction material. In certain examples, the aggregate and the hybrid additive may be provided at 85 wt. % to 99.5 wt. % based on a total weight of the hybrid construction material, wherein the hybrid additive is provided at 2 wt. % to 4 wt. %. Moreover, the hybrid additive may be formed as pellets, spheres, aggregate, or sand as described hereinabove.

The asphalt-based construction material may be formed into a flexible paving structure according to a method comprising: heating aggregate to a temperature of 105 C to 400° C. (e.g., to drive off moisture), lowering the temperature of the aggregate to below 175° C., dry mixing the hybrid additive with the aggregate to form a dry mix, adding the dry mix to a heated asphalt binder to form the hybrid construction material, and compacting the hybrid construction material at 85° C. to 175° C.

The asphalt-based construction material may be formed into a flexible paving structure according to a method comprising: heating aggregate to a temperature of 105 C to 400° C. (e.g., to drive off moisture), dry mixing the hybrid additive and recycled asphalt materials (e.g., reclaimed asphalt pavement), with the aggregate to form a dry mix, adding the dry mix to the heated asphalt binder to form the hybrid construction material, and compacting the hybrid construction material at 85° C. to 175° C.

When the flexible paving structure is formulated with 2 wt. % to 4 wt. % of the hybrid additive, performance enhancements to the paving structure as compared to a paving structure formed without the hybrid additive are found to include one or more of: reduced rut depth by at least 50% as measured by a Hamburg Tracking Wheel (HWT) test, increased moisture resistance by at least 50% as measured by stripping inflection points (SIP) from a set of HWT tests, increased cracking resistance by approximately 5% as measured by a Disc-shaped Compact Tension (DCT) test, and reduced absorption of the binder into the aggregate by at least 50%.

According to certain aspects, when the hybrid construction material is configured as a cementitious construction material, it may comprise 0.5 wt. % to 30 wt. % of a cementitious binder, 10 wt. % to 60 wt. % of the hybrid additive, and an aggregate, wherein the wt. % is based on a total weight of the hybrid construction material. In certain examples, the aggregate and the hybrid additive may be provided at 70 wt. % to 99.5 wt. % based on a total weight of the hybrid construction material, wherein the hybrid additive is provided at 10 wt. % to 40 wt. %. Moreover, the hybrid additive may be formed as pellets, spheres, aggregate, or sand as described hereinabove.

The cementitious construction material may be formed into a cementitious structure according to a method comprising: dry mixing the cementitious binder, aggregate, and hybrid additive of the hybrid construction material at ambient conditions to form a dry mix, and adding sufficient water to the dry mix to form a cementitious slurry that cures to form the cementitious structure.

When the cementitious structure is formulated comprising 10 wt. % to 40 wt. % of the hybrid additive, performance enhancements of the structure as compared to a structure formed without the hybrid additive are found to include one or more of: improved resistance to chemical wear by at least 50% and improved resistance to mechanical wear by at least 50%, as measured by an L.A. Abrasion test.

### BRIEF DESCRIPTION OF THE DRAWINGS

Aspects, features, benefits, and advantages of the embodiments herein will be apparent with regard to the following description, appended claims, and accompanying drawings.

FIG. 1 is a graph showing rutting performance of hybrid composite construction materials (hybrid composite) comprising varied amounts of a hybrid additive according to aspects of the present disclosure when used in flexible paving applications.

FIG. 2 is a graph showing moisture resistance performance of hybrid composites comprising varied amounts of a hybrid additive according to aspects of the present disclosure when used in flexible paving applications.

FIGS. 3A and 3B are graphs showing variability of rutting performance of a hybrid composite according to aspects of the present disclosure when used in flexible paving applications.

FIGS. 4A and 4B are graphs showing strength performance and performance variability of a hybrid composite according to aspects of the present disclosure when used in flexible paving applications.

FIG. 5 is a graph showing low temperature cracking performance of hybrid composites comprising varied amounts of a hybrid additive according to aspects of the present disclosure when used in flexible paving applications.

FIG. 6 is a graph showing intermediate temperature cracking performance of a hybrid composite comprising the hybrid additive according to the present disclosure, wherein the data is based on the IDEAL-CT Index.

FIG. 7 is a graph showing rutting performance for different binder grades of hybrid composites according to aspects of the present disclosure when used in flexible paving applications.

FIG. 8 is a graph showing distribution of microplastics in water samples from Hamburg wheel tracking (HWT) testing of asphalt specimens without and with the hybrid additives according to the present disclosure.

FIG. 9 is a graph showing compressive strength over time for hybrid composites formed with different quantities of aggregate replacement with a hybrid additive according to the present disclosure when mixed with typical quantity of Portland cement (590 lbs./cy).

FIG. 10 is a graph showing compressive strength over time for hybrid composites formed with different quantities of aggregate replacement with a hybrid additive according to the present disclosure when mixed with reduced quantity of Portland cement (540 lbs./cy).

FIG. 11 is a graph showing the unit weight for hybrid composites formed with different quantities of aggregate replacement with a hybrid additive according to the present disclosure.

FIGS. 12A and 12B are graphs showing compressive strength over time for hybrid composites formed with different quantities of aggregate replacement with various hybrid additives according to the present disclosure.

### DETAILED DESCRIPTION

The present invention is related to an engineered structural polymer-binder construction material, hereinafter referred to as hybrid additive, that maintains the positive performance aspects of typical asphalt and concrete mixtures, while improving the performance of the mixtures by increasing bonding and strength within the mixture—and therefore increasing useable life and lowering costs. The present invention is further related to hybrid composite construction materials comprising the hybrid additive, hereinafter referred to hybrid composites, and methods of making the hybrid additive and hybrid composites comprising the hybrid additive.

### Definitions and Abbreviations

Throughout this description and in the appended claims, use of the singular includes the plural and plural encompasses singular, unless specifically stated otherwise. For example, although reference is made herein to “an” aggregate, “a” composite, and “the” additive, one or more of any of these components and/or any other components described herein can be used.

The word “comprising” and forms of the word “comprising,” as used in this description and in the claims, does not limit the present invention to exclude any variants or additions. Additionally, although the present invention has been described in terms of “comprising,” the composites detailed herein may also be described as consisting essentially of or consisting of. For example, while the invention has been described in terms of a hybrid composite comprising a hybrid additive, a binder, and one or more aggregates, a hybrid composite material consisting essentially of a hybrid additive, a binder, and one or more aggregates is also within the present scope. In this context, “consisting essentially of” means that any additional materials or components will not materially reduce the strength or durability of the hybrid composite material formed therefrom.

The term “substantially” should be understood to mean that the noted value is within 20% of a comparative value, shape, or size, such as within 15%, or 10%, or 5%, or 2%, or even 1%.

Furthermore, the use of “or” means “and/or” unless specifically stated otherwise. “Including” and like terms means including but not limited to. When ranges are given, any endpoints of those ranges and/or numbers within those ranges can be combined within the scope of the present invention.

Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and appended claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

The term “aggregate” is used herein to denote any hard, inert, typically mineral material that is bound together by a binder. Examples of aggregate used in construction or paving mixtures include marble, limestone, basalt, dolomite, sandstone, granite, and quartzite. RAP, crushed glass, glass beads, and crushed Portland cement concrete (PCC) are also used as aggregate. Furthermore, aggregate can be from natural or manufactured sources. Aggregates can also include manufactured aggregates from intentional heating of materials, such as lightweight aggregates composed of expanded clay and shale, and aggregates that are byproducts of other materials such as slag from production of metals. Aggregates in paving materials typically range from less than 50 mm (2 inches) to fine dust that passes through the #200 US sieve (75 microns). Any of various known grades of aggregate and gradation can be used in the practice of this invention, including dense graded, uniform graded, gap graded, and open graded used for any type of pavement including highways, bridges, roads, parking lots, recreation trails, sidewalks, sporting facilities, and porous pavements.

The term “binder” is used herein to denote any material that binds, glues, adheres, or bonds aggregates together. Examples of common construction material binders include but are not limited to asphalt binder, made from natural or refined asphalt or a mixture of both sources, tar, Portland cement, cements, pozzolans, epoxies, glues, adhesives, grouts, clays, and hydrated lime that can come in solid, liquid, emulsion, slurry, powder, pelletized, or gaseous form.

The term “hybrid additive” is used herein to denote any material that improves the bonding of a construction composite in order to achieve the desired performance properties, such as strength, moisture resistance, resistance to deformation, and cracking resistance. The hybrid additives disclosed herein generally comprises polymers with additional materials incorporated therein and optionally coated on a surface thereof.

### Aspects of the Present Disclosure

The hybrid additives of the present invention may be used in novel construction materials, such as the hybrid composites disclosed herein, and as additives in standard construction materials. For example, two main uses of the hybrid additives disclosed herein include, but are not limited to, hybrid composite asphalt paving and construction materials and hybrid composite cement/concrete paving and construction materials. The hybrid composites produced therefrom maintain the positive performance aspects of asphalt and concrete paving and construction materials, while improving the performance of the mixtures and end products by increasing bonding strength and in some cases lowering weight within a mixture—and therefore increasing useable life, lowering costs, and enabling new applications heretofore unattainable due to current mix, production, cost, and usage limitations.

Accordingly, disclosed herein is a hybrid additive comprising at least virgin and/or recycled materials from industrial or consumer sources of structural polymers. Also disclosed herein are hybrid composite construction materials comprising the hybrid additive, hereinafter referred to hybrid composites. Also disclosed herein are methods of forming the hybrid additive, and methods of making the hybrid composites comprising the hybrid additive.

### Hybrid Additive

The disclosed hybrid additives generally comprise plastics and/or polymer materials from virgin and/or recycled sources and additional materials.

The hybrid additive may comprise the plastics and/or polymer materials at from 50 wt. % to 99.9 wt. %, such as at least 50 wt. %, or 55 wt. %, or 60 wt. %, or 65 wt. %, or 70 wt. %, or 75 wt. %, or 80 wt. %, or 85 wt. %, or 90 wt. %, or 95 wt. %, or not more than 99.9 wt. %, such as not more than 95 wt. %, or 90 wt. %, or 85 wt. %, or 80 wt. %, or 75 wt. %. An upper and lower value may define a range of inclusion for the plastics and/or polymer materials in the hybrid additive, such as from 50 wt. % to 99.9 wt. %, or 75 wt. % to 99.9 wt. %, 85 wt. % to 99.9 wt. %, 90 wt. % to 99.9 wt. %, 95 wt. % to 99.9 wt. %.

Exemplary plastic or polymeric materials include elastomers, plastomers, ethylenes, styrenes, or other recycled or virgin plastics or polymers. For example, the plastic or polymeric material may be any one or more of the type 1-7 recyclable plastics, including but not limited to one or more of polyethylene terephthalate (PET or PETE), high-density polyethylene (HDPE), polyvinyl chloride (PVC), low density polyethylene (LDPE), polypropylene (PP), and polystyrene (PS). Additional exemplary plastic or polymeric materials include acrylonitrile butadiene styrene (ABS), polycarbonate (PC), polyamide (PA, also known as nylon), polyethylene (PE), medium density polyethylene (MDPE), ultra-high molecular weight polyethylene (UHMWPE), polymethyl methacrylate (PMMA), and polytetrafluoroethylene (PTFE, also known as teflon) in compacted, heat-treated, or gas-expanded form.

The hybrid additive may comprise the additional materials at from 0.1 wt. % to 50 wt. % of the total weight of the hybrid additive, such as at least 0.1, 0.5, 1, 2, 3, 4, 5, 6, 7, 8, 9, 10 wt. %, or up to 20, 25, 30, 35, 40, 45, or 50 wt. %, based on the total weight of the hybrid additive. The additional materials may be coated on the hybrid additive or included in the hybrid additive in a range comprising any combination of lower and upper limits indicated herein, such as from 0 wt. % to 40 wt. %, or from 0.1 wt. % to 20 wt. %, or 0.1 wt. % to 30 wt. %, or from 0.1 wt. % to 5 wt. %, etc. According to preferred aspects, the additional materials are included in the hybrid additive.

Exemplary additional materials include, but are not limited to, fibers, pozzolans, nano-carbon tubes, glass, recycled asphalt shingles (RAS), liquid anti-strip, hydrated lime, rejuvenators, graphene, cementitious material (e.g., calcium carbonate, fly ash, slag cement, silica fume, etc.), ground tire rubber, and the like. These materials may be incorporated into the hybrid additive and optionally may also be included as a coating on an exterior surface of the hybrid additive.

According to certain aspects, the disclosed hybrid additive may be formed to be structurally similar to known construction materials and additives. For example, the hybrid additive may be formed as an aggregate, e.g., gravel, having diameters of from 2 mm to 75 mm, such as from 2 mm to 50 mm, or from 2 mm to 20 mm. The hybrid additive may be formed as a sand having diameters of from 0.02 mm to 2 mm, such as from 0.02 mm to 0.125 mm, or from 0.125 mm to 0.25 mm, or from 0.25 mm to 0.5 mm, or from 0.5 mm to 2.0 mm. The hybrid additive may be powderized and may have a diameter of from about 5 micrometers (um) to 250 um, such as 5 um to 200 um, or 10 um to 150 um, or 25 to 125 um.

The aggregate and/or sand forms of the hybrid additive may have shapes with one or more vertices, such as multifaceted structures, and/or may be substantially flat on at least one side, such as flakes. Alternatively, the sand form of the hybrid additive may be substantially round or sub-rounded in shape.

An exemplary method for forming these hybrid additives, i.e., the aggregate and sand forms thereof, includes grinding, such as in a granulator, the plastic and/or polymer with the additional materials, wherein heat during the grinding process causes the additional materials to become stably incorporated with the polymer and/or plastic. Alternatively, the polymeric or plastic material may ground in a first grinding step to reduce the plastic to shredded material, followed by mixing with the additional material, melting to form a combined material, and then grinding a second time to gain the desired shape and size of the hybrid additive. When powderized, the size may be reduced using methods such as, but not limited to, rolling ball mills, cryogenic mills, crushing, shearing, and/or blowing air into the fabrication.

The hybrid additives may be formed so that they are structurally different from other known construction materials and additives. More specifically, in certain implementations, the form and/or shape of the hybrid additive has been designed to make addition of the hybrid additive easier during production of hybrid composites, such as production of a composite material at an asphalt plant or cement/concrete plant. The shape of the additive is designed to allow the additive to be transported easily by different conveyance systems such as pneumatic, pressurized or vacuum, mechanical conveyance systems such as linear continuous conveyances (e.g., belts or augers) or discrete quantity conveyances (e.g., hopper or bucket), or typical mobile mechanized equipment available at asphalt or concrete plants such as front-end loaders, dump trucks, bucket trucks, cranes, forked lifts, and scissor lifts, that are used for transporting aggregates and other bulk goods, such as hydrated lime, cement, and fibers, around an asphalt plant or sand, gravel and cement components at a concrete plant.

The hybrid additive may be formed as a pellet having a roughly cylindrical shape with a slight curvature at the ends to increase the rolling resistance of the pellet yet still allow the pellets to flow into/out of bulk quantities. The length of the pellet may be 3 mm to 20 mm, such as at least 3 mm, or 4 mm, or 5 mm, or 6 mm, or 7 mm, or 8 mm, or 9 mm, or at least 10 mm, and not more than 20 mm, or 19 mm, or 18 mm, or 17 mm, or 16 mm, or 15 mm, or 14 mm, or 13 mm, or 12 mm, or 11 mm, or not more than 10 mm. Any upper and lower value may define a range of lengths for the pellet, such as 3 mm to 13 mm. The diameter of the pellet may be 1.0 mm to 13 mm, such as at least 1.0 mm, or 1.5 mm, or 2 mm, or 3 mm, or 4 mm, or 5 mm, or 6 mm, or 7 mm, or 8 mm, or 9 mm, or at least 10 mm, and not more than 20 mm, or 19 mm, or 18 mm, or 17 mm, or 16 mm, or 15 mm, or 14 mm, or 13 mm, or 12 mm, or 11 mm, or not more than 10 mm. Any upper and lower value may define a range of diameters for the pellet, such as 1.5 mm to 9 mm.

The pellet may include curvature at one or both ends, wherein the curvature may be from 1° to 45°, relative to a longitudinal axis of the pellet, such as from 1° to 30°, or from 1° to 20°, or from 1° to 15°, or from 1° to 10°. When included at both ends, the curvature at each end of the pellet may be in the same direction or may be a deflection from the longitudinal axis in any axial direction. Furthermore, the sizing may be consistent within 10% of the nominal dimension, and ideally within 5%, which improves the flowability of the additive. The surface texture of the hybrid additive is typically smooth but can be adjusted in the manufacturing process to improve the movement of the material.

The hybrid additive may be formed to have a substantially spherical shape having a nominal diameter of 1.0 mm to 20 mm, such as 1.0 mm to 15 mm, or 1.6 mm to 13 mm, or 3 mm to 15 mm, or 4 mm to 13 mm, or 3 mm to 20 mm. The substantially spherical shape has certain advantages, such as a high crush strength due to its geometry.

When formed to have any of the aforementioned shapes (e.g., aggregate, roughly cylindrical, spherical shape), the hybrid additive may be filled with air or other additives to improve the composite mixture and may or may not have a coating on the outside surface thereof. That is, the hybrid additive may be modified by utilizing foaming processes or agents to lighten the additive, e.g., provide an expanded form of the additive, and to introduce properties that allow increased dispersion in asphalt production and enable production of lightweight concrete and concrete products with enhanced insulative properties, or other construction material applications that provide economic or usability benefits from the lighter weight and improved insulative properties. Exemplary uses include at least concrete in high-rise buildings, concrete housing, infrastructure components such as bridge beams, lightweight roof tiles, blocks, panels, pavers, poured cement, and other lightweight concrete or construction materials. Moreover, use of the hybrid additive in the expanded form may provide large savings in transporting prefabricated components made with the hybrid composites comprising the hybrid additive, and/or ready to use mixtures comprising the hybrid additive, i.e., hybrid composites.

Of note, the various dimension ranges provided herein for the hybrid additive when formed as a powder, sand, aggregate, pellet, or sphere, may be an unexpanded dimension or may be inclusive of the expanded dimension or size. The hybrid additive may have an expanded size or dimension that is 2, 5, 10, 15, 20, 25, 30, 35, or even 40 times greater than the unexpanded dimension or size.

The surface of the hybrid additive may be textured to increase the surface macro- and micro-textures, and thereby the bonding of the hybrid additive with components of the construction matrix (e.g., components of a composite material disclosed herein). Texture may include indentations, dimples, inclusions, and the like.

An exemplary method of forming the pellets and/or spherically shaped hybrid additive includes grinding the plastic, mixing with the additional materials, melting the mixture, and extruding the mixture which is cut into pellets or other shapes. Further exemplary methods include stamping/pressing techniques that bond the materials together and allow a variety of shapes to be formed.

The disclosed hybrid additives are also unique in that they may have a melting temperature optimized for usage in the hybrid composites. For example, when producing a hybrid asphalt composite, the hybrid additives disclosed herein are designed to melt and become part of the overall chemistry of the end material mix. In this implementation, a preferred melting temperature of the hybrid additive is within the range of 95° C. to 140° C. (200° F. to 285° F.), with an optimum melting temperature of 105° C. to 115° C. (220° F.-240° F.). The melting temperature of the material is high enough to eliminate the need for specialized storage, such as avoiding direct sunlight or requiring air-conditioned spaces, yet low enough to allow it to melt easily during asphalt mixture production, including warm-mix asphalt. Furthermore, the melting point is important to ensure thorough, even distribution of the additive through the hybrid asphalt composite during mixing.

The hybrid additive may further include coatings, such as with cementitious material that includes calcium carbonate, hydrated lime, graphene, and/or pozzolanic materials. These materials may be included at from 0 wt. % to 50 wt. % of the total weight of the hybrid additive (e.g., aggregate, pellet, etc.), such as at least 0.1, 0.5, 1, 2, 3, 4, 5, 6, 7, 8, 9, 10 wt. %, or up to 20, 25, 30, 35, 40, 45, or 50 wt. %, based on the total weight of the hybrid additive. The coatings may be included on an external surface in a range comprising any combination of lower and upper limits indicated herein, such as from 0 wt. % to 40 wt. %, or from 0.1 wt. % to 20 wt. %, or 0.1 wt. % to 30 wt. %, or from 0.1 wt. % to 5 wt. %, etc. The coatings may be included as a powder that becomes integrated within the surface texture of the hybrid additive, i.e., within the dimples, inclusions, crevices, etc., that are on the surface.

The coatings may be dry coatings that are added to the hybrid additive using methods known in the art, such as tumblers, or via pre-heated or adhesive applied methods to bond the coatings to the surface of the hybrid additive. The coatings may be added as a wet mixture that is dried before the hybrid additive is used in a construction material, such as the hybrid composites disclosed herein.

The hybrid additive may be ultraviolet light (UV) resistant, which means the material fades in color less than typical construction materials. This is beneficial for many applications. One application is asphalt pavements that stay darker longer, which can provide a safety benefit of the ability to distinguish the painted strips from the pavement in the dark or rainy conditions. Another application is prefabricated elements that do not fade as quickly as current materials in sunlight.

When included in an asphalt construction material, the additive may provide performance enhancements such as reduced rutting, increased strength, and reduced moisture sensitivity. When included in a concrete or cementitious construction material, the additive may provide performance enhancements such as increases in the insulation value, particularly when in an expanded form, reduction in the variability of surface water and the absorption of water, improved resistance to salts and minerals, and increased durability.

### Hybrid Composite

Also disclosed herein are hybrid composites generally comprising an aggregate, a binder, the hybrid additive, and optionally, additional additives. The dry components are introduced through a unique dry process during production of the hybrid composite, wherein the dry components including the aggregate, binder, and hybrid additive are blended to produce the hybrid composite paving material. In the application of hybrid additive to an asphalt mixture, the hybrid additive is generally not blended into the binder before the binder is mixed with the aggregate.

Exemplary aggregates include naturally occurring or manufactured aggregate, sand, screenings, dust, or aggregates known to be used in paving and construction materials by those skilled in the art.

Exemplary binders include asphalt, tar, pozzolans (generally, but not limited to, aluminosilicate materials mixed with calcined lime), Portland cement, supplementary cementitious materials, hydrated lime, asphaltite, calcium carbonate, epoxies, clays, including virgin or recycled/reclaimed sources or both, in dry, slurry, emulsion, liquid, or gaseous form. Further exemplary binders include asphalt binder, crushed asphalt pavement, concrete products, asphalt shingles, glass, natural and synthetic rubber, and/or wood. Each of the binders disclosed herein may include virgin sourced materials, recycled/reclaimed materials, or a combination of both.

Exemplary optional additives used in paving mixtures known to those skilled in the art may include, but are not limited to, (a) liquid anti-strip additives, such as an amine-based or organosilane-based additives, or hydrated lime (calcium hydroxide); (b) fibers, including cellulose, aramid, steel, glass, fiberglass, polymeric, and carbon; (c) warm-mix additives that modify production and/or paving temperature of a paving mixture, including waxes, chemical, and steam treatments; (d) additives that improve workability of the paving mixture, such as plasticizers, water-reducing admixtures, waxes, such as Sasobit; and (e) additives that improve binder coating of the aggregate, such as surfactants, soaps, and waxes.

Exemplary optional additives further include additives that modify the binder, including (a) polymers to improve elasticity of the mixture, such as elastomers, reactive elastomeric terpolymer, styrene-butadiene-styrene (SBS) polymers, and styrene-butadiene rubber (SBR) copolymers; (b) ground tire rubber or other rubber compounds; (c) materials to increase the light oil fraction, e.g., maltene matrix, in asphalt binders, including additives based on oils from plants, such as soy, canola, sunflower, coconut oil, tall oil, and additives from refined processes such as virgin oils or reclaimed engine oil bottoms (REOB); and (d) acids including polyphosphoric acid.

Exemplary optional additives further include graphene, carbon nanotubes, and/or other engineered or naturally occurring organic or inorganic structural composites.

A hybrid composite for use as an asphalt paving material may comprise the following components: aggregates; asphalt binder and/or SBR- and SBS-modified asphalt binder; RAP; and the hybrid additive. As example in an asphalt application, these components include the aggregate; RAP; SBS and SBR polymer-modified asphalt binder; and a hybrid additive such as a pelletized agglomeration of polyolefin polymers, including polyethylene and polypropylene polymers, cementitious materials such as pozzolans, nano-carbon tubes, glass, RAS, and/or other structural materials such as ground tire rubber and graphene. The hybrid additive may further comprise additional materials such as liquid anti-strip, hydrated lime, and/or asphalt rejuvenators.

The components of the hybrid asphalt composite are mixed at an elevated temperature of at least 85° C. (176° F.) but less than 400° C. (750° F.) until uniform coating is achieved.

It should further be noted that the following components in the hybrid additive can be incorporated into the hybrid asphalt composite without being contained in the hybrid additive itself, or in addition to any amounts that are contained in the hybrid additive. For example, each of pozzolans, nano-carbon tubes, glass, RAS, liquid anti-strip, hydrated lime, rejuvenators, and ground tire rubber may be incorporated into the hybrid asphalt composite separate from the hybrid additive. The RAS, pozzolans, nano-carbon tubes, glass, and hydrated lime must be sufficiently dry to allow the material to flow through the material handling process and prevent adding additional moisture to the hybrid asphalt composite during mixing.

The RAS is generally dried to less than 2% moisture using a typical drying system that keeps the RAS below 200° C. to prevent excessive aging of the RAS. The rejuvenator may need sufficient time to react with the RAS incorporated into the hybrid additive based on the recommendations of the rejuvenator manufacturer. Furthermore, the hybrid additive may be introduced into the asphalt mixing process when the temperature is within this temperature range (105° C. to 180° C.). To achieve this temperature range, the hybrid additive may be introduced after the aggregate has been heated for mixing. The hybrid additive may be introduced at an intermediate stage in the mixing process with the binder or through a portal, such as a RAP, fiber, or baghouse fines port.

According to additional aspects of the present disclosure, a hybrid composite for use as a cementitious construction material, i.e., hybrid cementitious composite, may comprise aggregate; cement; secondary cementitious materials, such as fly ash, bottom ash, pozzolans, silica fume, and calcined clays; a hybrid additive comprising a blend of structural polymers and additional materials, optionally in an expanded form, that are coated with cementitious material that includes calcium carbonate and pozzolanic materials; and water.

For this hybrid cementitious composite blend, the temperature is not elevated beyond ambient temperature. The surface of the hybrid additive may be intentionally textured to increase the surface macro- and micro-textures, and thereby the bonding of the hybrid additive with the cement matrix that develops within the construction composite. Furthermore, the pelletized or spherical hybrid additive may contain dimples, indentations, inclusions on the surface thereof, and these indentations may contain cementitious material. The additional cementitious material provides additional material to promote bonding between the hybrid additive and the cement paste.

The primary strength of the hybrid cementitious composite is developed through the pozzolanic reaction. The structural polymers of the hybrid additive provide additional strength through increased cementitious material, when included, and a surface that is sealed and does not absorb moisture during the curing process to improve the long-term hydration reaction at the hybrid additive-cement matrix interface (e.g., pellet-cement mixture interface). In addition, the blend of structural polymers of the hybrid additive may include fibers, that include but are not limited to aramid, steel, cellulose, hemp, and carpet fibers, and glass in a variety of forms including but not limited to pelletized, crushed, and powdered forms, to improve the strength and cracking resistance of concrete mixtures. The fibers may be incorporated into the blend during production of the hybrid additive. Incorporating the fibers into the hybrid additive(s) improves material handling of fibers because the hybrid additives have sufficient density that they can be easily introduced into the composite mixture without blowing away.

Another benefit of fibers contained in a hybrid additive that can easily be mixed into and dispersed within a cement composite mixture is the dispersed fibers strengthen and create additional bonds between the interface of the hybrid additive and the cement matrix that improve the resistance to cracking of the concrete composite.

Additional applications of the hybrid composites disclosed herein include a variety of applications in which the construction or paving material is prefabricated or pre-formed. The pre-formed applications can be manufactured and formed into desired shapes by known manufacturing methods including but not limited to heating, molding, extruding, rolling, stamping, casting, machining, water-jet or laser cutting, additive manufacturing, or other manufacturing processes utilized to form, mold, or manufacture components using the invention to create end-use construction materials and/or components. The components can be pre-formed in a manufacturing facility, on-site, or in-situ. The prefabricated components can be auxiliary applications to paving including curbs, corners, roundabouts, driveways, sidewalks.

The prefabricated components can be part of a process that uses prefabricated components to quickly install and build common pavements, such as sidewalks, parking lots, and driveways, with standardized pieces that can be installed without specialized paving equipment. The pieces can be interlocking or placed beside or near each other and the gap between pieces can be filled with aggregate or fillers used to fill joints, cracks, or gaps in pavements including but not limited to crack sealants, asphalt mixtures, and expansion joint materials.

For vertical construction, the hybrid composite can be formed on-site or prefabricated into components including blocks (hollow or solid), wall, panels, beams, frames, conduits, pipes, doors, piers, footings, pilings, floors, flooring, tiles, shingles, pavers. The hybrid composite can be applied to or inserted between other surfaces using techniques such as spraying, troweling, texturing, stuccoing, mud jacking, and grouting in vertical construction and geotechnical applications to achieve one or more of the following purposes: coat, texture, decorate, waterproof, finish, and/or fill. This application of the hybrid composite increases speed of construction and reduces the labor required for these applications.

The disclosed hybrid composites are unique when compared with other known construction materials because they demonstrate significant improvements in all aspects of standard construction material performance, e.g., asphalt, concrete, etc. For example, bonding of mixture components, rutting/denting/deformation resistance, cracking resistance, and moisture resistance are all improved for the presently disclosed hybrid composites when compared to standard materials.

Addition of the presently disclosed hybrid additives to standard construction materials such as asphalt or concrete, or exchange of amounts of standard materials in concrete or asphalt for the hybrid additives, renders these standard materials much improved across a range of standard performance metrics. That is, the hybrid additive improves many of the performance parameters and benefits of other high tensile and compressive strength materials, such as fibers. For example, and as discussed in more detail in the examples section of this disclosure, the hybrid additive provides significant increases in performance of hybrid composites over conventional asphalt or prior polymer modified asphalts in all key aspects of material performance and therefore can lower costs and/or allow additional uses beyond the capabilities of currently available mixes or additives.

Areas of increased performance of the hybrid composites comprising the hybrid additives include at least increased strength, rutting resistance, moisture resistance, and cracking resistance. Without wishing to be bound by one theory, the increased performance likely originates from increased bonding as a result of inclusion of the hybrid additive, i.e., structural polymers of the hybrid additive increased bonding between different sources of aggregate and binder. A clear advantage of the present hybrid additive is that the increased performance is achievable by methods that do not require specialized equipment to implement at the material production facility.

Improved performance is also observed as consistent increases in paving mixture stiffness, e.g., asphalt stiffness, without requiring polymer modification of the binder by the producer but instead allowing modification at the production plant by the producer. That is, the producer may include the hybrid additive during production of the paving composition at the plant. This obviates the need for the producer to source specialized asphalt and/or aggregates. Moreover, the hybrid additive provides for increased RAM content, up to 100%, with better bonding and without the complications of material inconsistency, e.g., provides superior material consistency.

The hybrid additive further provides tunable and scalable performance behavior of the hybrid composite (strength, rutting, stripping, tensile/compressive strength, temperature performance, moldability, etc.) that increases linearly as the amount of hybrid additive increases. Not only are performance characteristics improved, but the consistency of test performance data for rutting, cracking (fatigue, thermal, reflective, shrinkage) is improved. Moreover, the present inventors have found that the improved performance may occur by increasing the effective binder content on the surface of the aggregate and decreasing the absorption of the binder into the aggregate.

The hybrid additive may perform as an anti-strip additive in the hybrid composites, such as asphalt mixtures used for paving. Antistrip additives are commonly used by many highway agencies to improve the water resistance of asphalt concrete mixtures. Moreover, the hybrid additive may provide anti-strip properties to fiber additives that are used to increase strength in such paving composites.

The hybrid additives may also be useful in construction materials in which the material is prefabricated or preformed into auxiliary components including but not limited to curbs, corners, roundabouts, pavers, bricks, roof tiles or shingles, siding, dimensional lumber alternatives, roads, airport landing strips, bridge components, modular building units, beams, trusses, or other residential, commercial, or government/military applications.

As mentioned hereinabove, the disclosed hybrid additives may act as a polymerized anti-strip additive in asphalt mixes. The hybrid additive improves bonding between the aggregate and binder by bridging the stiff and fluid components of the asphalt binder and creating links to and between the binder and aggregate. The improved bonding increases the moisture resistance of the asphalt mixture, as demonstrated by the increased stripping inflection point (SIP) of the Hamburg Wheel Tracker test (AASHTO T 324). The SIP is the intersection of two behaviors during the test: the creeping behavior, a gradual deformation of the mixture, and the stripping behavior, a rapid deformation that signifies the mixture has lost its internal stability due to moisture and composition. A large SIP is desirable because it means more passes of a loaded wheel are needed before the mixture becomes unstable.

The hybrid additives may improve the bonding within a cement mixture by improving the bonding between the aggregate and cement paste. The pelletized or spherical hybrid additive may have a texture that increases the surface area and increases the wettability of the hybrid additive, which allows the development of a strong interface between the additive and cement paste.

The hybrid additives are unique in that they may be added in a dry mix process to produce the hybrid composite material, such as an asphalt, concrete, or construction composite. This ability gives the material producer greater control over the product produced and allows more precisely engineered materials because the hybrid additive dosage can be varied to meet the strength and deformation, cracking, and moisture resistance requirements of the mixture without negatively influencing other desirable mixture performance, such as a trade-off of decreased cracking resistance for increased rutting resistance. Previous attempts to use the dry process have had limited success because of issues with consistency. The consistency of the hybrid additive in both material components and dimensions creates a new level of consistency of the mixture, which is born out through laboratory and field testing detailed in the examples disclosed herein.

The hybrid additives disclosed herein have been found to exhibit linear effects on performance characteristics. As example, a 1% addition of the hybrid additive to an asphalt mix produces significant gains in the performance parameters, and further additions, such as 2% and 3% demonstrate expected linear increases in the measured performance characteristic. This linear predictable improvement allows users to easily achieve any desired performance of the resultant hybrid composite with a consistently not available with prior asphalt or modified asphalt mixes, or with concrete mixtures.

The hybrid additives have been found to provide chemical bonds within the hybrid composite upon cure, e.g., exposure to elevated temperatures of at least 95° C. (200° F.). Moreover, the amount of the hybrid additive required to affect such binding is low. The low usage amount required to achieve a desired performance metric is typically 1-5% wt.% of total binder weight. Accordingly, the presently disclosed hybrid additives provide an economical and in many cases cost-saving results while minimizing the volume of material needed to achieve the target performance. This can allow the user to eliminate other additives and to utilize lower-grade, lower cost materials to achieve desired performance such as asphalt binder oils in asphalt and lower cost aggregates and cement ingredients in concrete—allowing higher profits to the producer and lower costs to the user for equivalent or higher performance compared to alternative materials or additives.

While the hybrid additives provide performance improvements at low usage amounts, the hybrid additive also provide significant improvements in hybrid composites at high volume amounts. That is, the hybrid additive may be included in hybrid composites as an additive and/or as a replacement for aggregate materials at from 0.01% to 100% by weight of volume without decreasing the strength of the construction material. As the percentage of aggregate replacement increases, the unit weight of the composite material decreases, which is beneficial for reducing the weight and thereby the supporting elements for a structure formed with the hybrid composite.

The present inventors have found that the hybrid additive bonds with and encapsulates other components of a composite construction material, such as the hybrid composites disclosed herein, which prevents materials from wearing off due to abrasion or weathering. The additional bonding prevents particles such as microplastics, ground tire rubber, and fine aggregates from wearing off the surface of the construction mixture and migrating into environmentally sensitive places such as waterways, wetlands, and drinking water sources.

Moreover, the hybrid additive reduces the absorption of the binder into the aggregate, which is a common problem of construction materials. Binder that is absorbed into the aggregate is not available on the surface to improve adhesion between aggregate particles, which negatively affects the economics and performance of the mixture. Furthermore, binder can selectively absorb into an aggregate, which means more desirable components of the binder absorb while less desirable components remain on the surface of the aggregate. In asphalt mixtures, the softer flexible components of asphalt binder may absorb more than the harder, more brittle, and aging-prone components, which remain on the surface of the aggregate; this process results in poor performance of the mixture.

This disclosure will now provide a more detailed and specific description that will refer to the accompanying experimental examples. The drawings and specific descriptions of the drawings, as well as any specific or alternative embodiments discussed, are intended to be read in conjunction with the entirety of this disclosure. The hybrid additives and hybrid composites comprising the disclosed additives exhibit performance gains in an asphalt and concrete mix examples. The invention may, however, be embodied in many different forms such as lumber and other applications and should not be construed as being limited to the embodiments set forth herein; rather, these embodiments are provided by way of illustration only and so that this disclosure will be thorough, complete, and fully convey understanding to those skilled in the art.

### EXAMPLES

### Example 1: Hybrid Asphalt Composites Comprising the Hybrid Additive

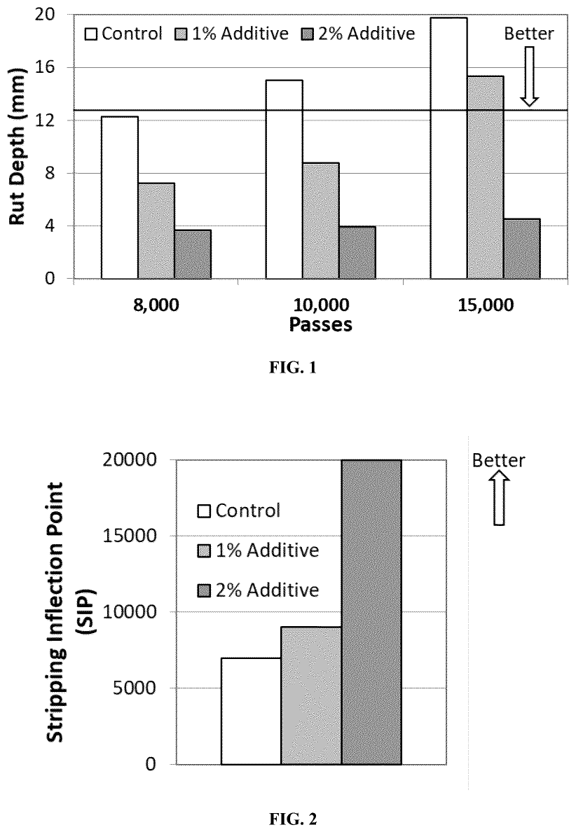

Hybrid additive according to the present disclosure was included in a typical asphalt pavement mixture. In FIG. 1, the results from Hamburg Wheel tracking (HWT, AASHTO T 324) tests are shown for a typical asphalt pavement mixture. The HWT test is used to evaluate rutting resistance of asphalt mixtures wherein a smaller rutting resistance number represents better performance.

In FIG. 1, a line is drawn at a rut depth (vertical axis) of 12.5 mm, which is the failure criterion. The control mixture fails between 8,000 and 10,000 passes. Addition of 1% of the presently disclosed hybrid additive (mixture the same as the control with addition of 1 wt. % based on total weight of the composition) improves the rutting resistance and cuts the rut depth by approximately 50%. Addition of 2% additive further improves the rutting resistance by reducing the 1% rut depth by an additional 50%. The 2% additive substantially increases the rutting resistance to the point that no rutting occurs. Additional testing has been performed with up to 10% hybrid additive and a linear increase in performance is observed. The results show that the percentages of the hybrid additive to the hybrid composite can be adjusted to achieve the desired performance. This ability to easily modify the performance is important because pavements and materials are designed and engineered to meet the traffic and environmental requirements, such as temperature and moisture, for a given location.

In FIG. 2, the stripping inflection points (SIP) from a set of HWT tests are shown. The stripping inflection point is a transition point in HWT testing in which the mixture transitions from slow, steady rutting or deformation to rapid rutting of deformation. Furthermore, the HWT test is performed with the specimens submerged in hot water (generally around 50° C. (122° F.) water). Therefore, the SIP indicates when moisture and heat cause the mixture to become unstable and lose its rutting resistance. An increased SIP is desirable because it indicates the mixture is stable and moisture resistant.

In FIG. 2, the SIP is shown to increase with addition of 1% and 2% hybrid additive in comparison to the control mixture (wt. % based on total weight of the composition). The SIP significantly increases for the 2% hybrid additive to 20,000 passes, which is the end of the test, signifying that the SIP or point of instability never occurred during this test. These results show that the hybrid composite asphalt mixture has greatly improved moisture resistance when the structural polymers are included in the mixture. This also shows that the hybrid additive can be used to replace common anti-strip additives such as liquid anti-strip and hydrated lime.

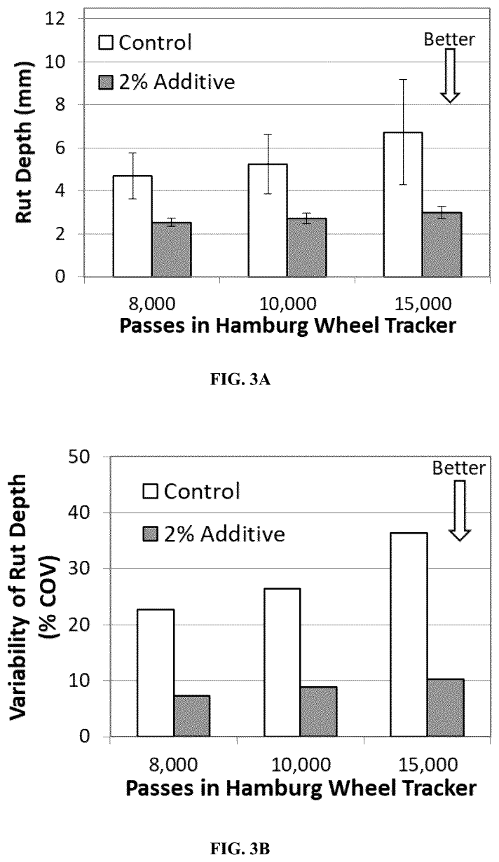

In FIGS. 3A and 3B, HWT test results from another asphalt mixture are shown. In FIG. 3A, the rutting results show that the hybrid additive at a dosage of 2% decreases the rut depth by approximately 50% at 8,000 passes compared to the control mixture, and the percentage increase in rutting resistance increases as the number of passes increases. In FIG. 3B, the variability of the results in FIG. 3A are shown. The variability is measured is terms of the coefficient of variation (COV), which is the standard deviation divided by the average multiplied by 100. The COV for the control mixture is greater than 20% at 8,000 passes and increases to 35% at 15,000 passes. Generally, a COV of less than 10% is considered good when testing asphalt mixtures due to the inherent heterogeneity of asphalt mixtures. The mixture with 2% hybrid additive reduces the COV below this threshold. This result shows that the hybrid asphalt composite mixture is more consistent than a standard asphalt mixture. Consistency is important because more consistency means the producer has better control when producing the hybrid composite, the product is more consistently performs as desired, and owners, such as federal, state, county, and city agencies and property owners such as shopping centers and distribution centers, can specify and receive more consistent products.

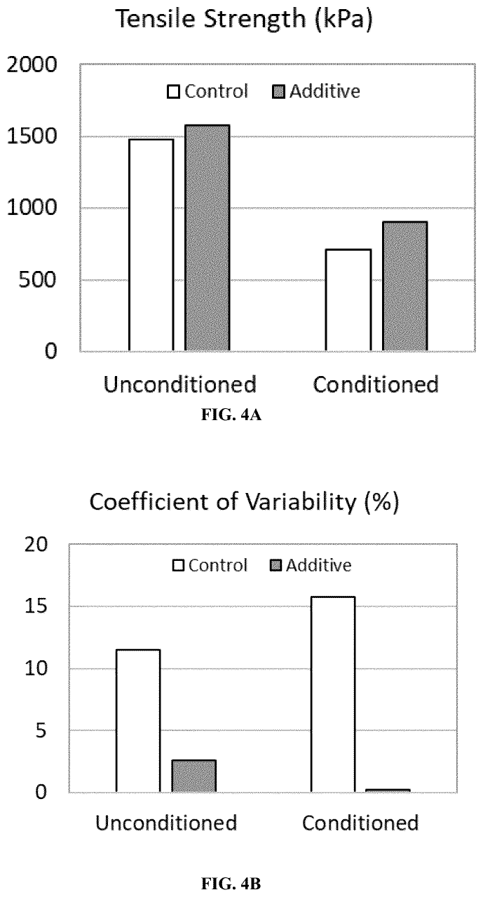

In FIGS. 4A and 4B, the tensile strength results are shown. Tensile strength is a common measurement of strength and an indicator of stiffness of asphalt mixtures. Tensile strength testing is commonly performed to evaluate the moisture resistance of asphalt paving mixtures by comparing the strength of unconditioned vs moisture conditioned specimens following the procedures in AASHTO T 283. The AASHTO T 283 method the change of diametral tensile strength resulting from the effects of water saturation and accelerated water conditioning with a freeze-thaw cycle.

The results in FIG. 4A show the tensile strength for both conditioned and unconditioned specimens. In both cases, including the hybrid additive increased the tensile strength. Increased strength is beneficial because it means a pavement can resist more load for a given thickness or be built thinner for a given level of traffic. The strength increase was larger for the conditioned specimens than the unconditioned specimens, which means the additive increases the moisture resistance as well as increases the overall strength. The results in FIG. 4B show the decreased variability of the test results. Like FIG. 3B, the control mixture had variabilities above 10%, but after including the additive, the variabilities decrease to less than 5%, which is particularly good for asphalt mixture testing.

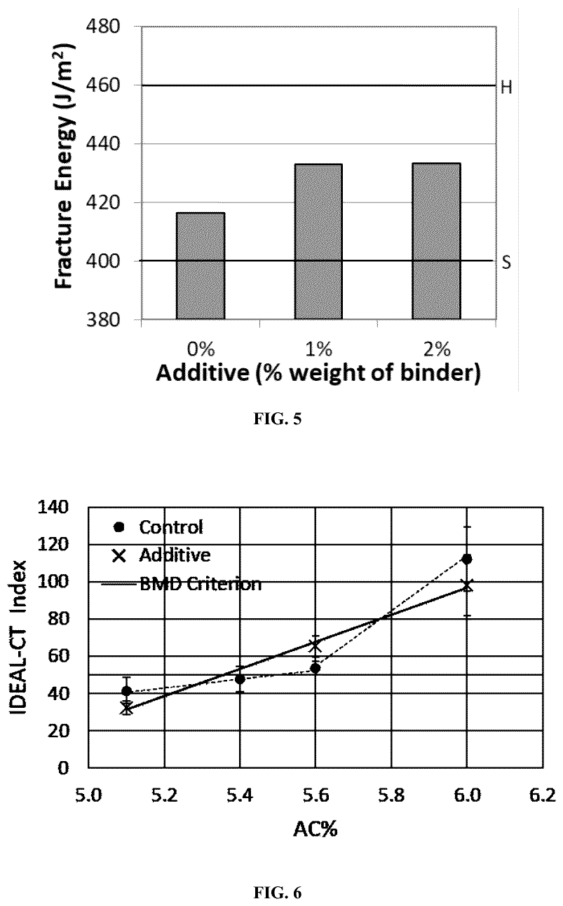

In FIG. 5, the fracture energy results from the Disc-shaped Compact Tension (DCT) test are shown. The DCT test is a test used to measure the low temperature cracking performance of asphalt mixtures. The test measures the energy it takes to crack a specimen. A higher fracture energy means it takes to more effort to crack a specimen and thereby the mixture is more resistant to cracking. The results show that the hybrid composite with the additive increased the cracking resistance by approximately 5%. This is significant, because many other additives included in asphalt mixtures tend to improve the rutting resistance at elevated temperatures to the detriment of the low temperature cracking because the additives create stiff, brittle mixtures. Conversely, other additives soften the mixture to improve low temperature performance, which causes excessive rutting at elevated temperatures.

In FIG. 6, the results from the Indirect Tensile Asphalt Cracking Test (IDEAL-CT) test are shown for different asphalt binder contents. The IDEAL-CT is an index test used to estimate the intermediate temperature (average yearly temperature, near room temperature) cracking performance of asphalt mixtures. The test measures the energy or effort it takes to crack a specimen and the rate the specimen cracks after the maximum load to calculate an index value. A higher IDEAL-CT index is desirable because it indicates a good balance between strength (the effort required to crack a specimen) and toughness (how quickly the specimen cracks). The IDEAL-CT index values were determined for different asphalt contents ranging from 5.1 to 6.0%. In this balanced mix design (BMD), the required IDEAL-CT index is at least 50. The control mixture was unable to meet the index threshold at 5.4%, which is the volumetric optimum asphalt content, so the asphalt content was increased to 5.6% for the control mixture. The results show that the hybrid composite with the additive increased the cracking resistance in a linear, predictable fashion, unlike the control mixture. The mixture with the hybrid additive could have passed at the volumetric optimum (5.4%) based on the linear trend.

One reason the mixture with the additive could have an optimum asphalt content 0.2 percentage points lower, which is a significant cost savings, is the hybrid additive improves the bonding between the aggregate and binder while coating the aggregate and making it less absorptive. When less asphalt binder is absorbed into the aggregate, the effective or free asphalt binder can resist cracking. The results show that the hybrid composite with the additive increased the cracking resistance in the IDEAL-CT by approximately 20% (from 54 to 65), which is a significant increase.

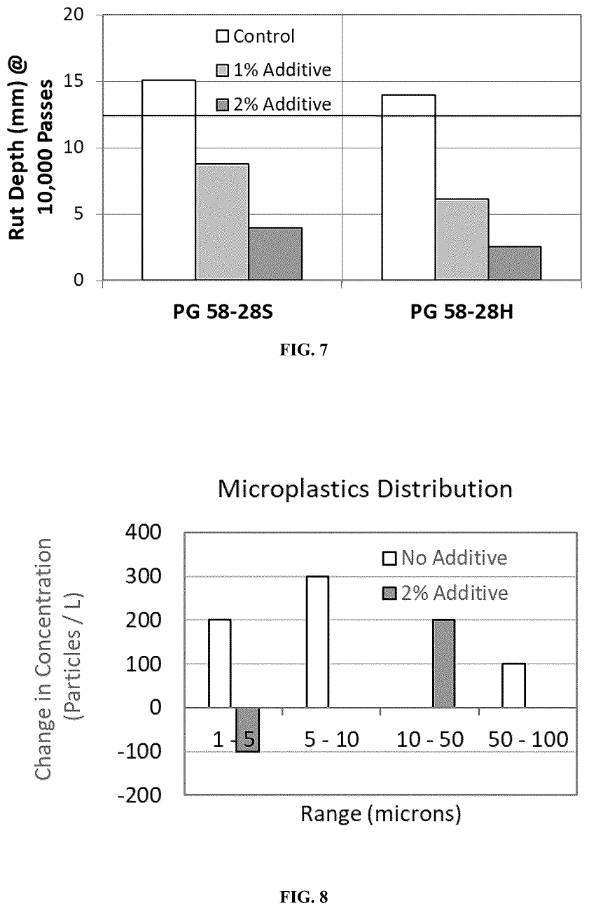

In FIG. 7, the rutting results for different binder grades are shown. Asphalt binders are graded or classified based on properties measured using several different tests at a range of temperatures. In the Performance Grading (PG) system, the tests are performed at elevated temperature for rutting resistance and intermediate and low temperatures for cracking resistance. In FIG. 7, the binders have the same low temperature cracking performance, as indicated by the −28, but different elevated temperature rutting performance, as indicated by the (S) for standard traffic and (H) for high traffic. To improve the performance from (S) to (H), polymer modification was added to the base (S) binder. As seen in FIG. 7, for a given binder, the inclusion of the hybrid additive decreased the rut depth by more than 50%, which is a desirable property. The figure also shows that polymer modification (H) only provides a little more rutting resistance than the base binder (S). The results show that increasing the binder grade from (S) to (H) for heavier traffic can be more effectively achieved using the hybrid additive that is introduced using a dry process instead of polymers mixed into the binder.

In FIG. 8, results of the distribution of microplastics are shown for an asphalt mixture with and without structural polymers. The chart shows the change in microplastic by comparing counts of particles per liter for the conditions of before (baseline) and after HWT testing. The HWT test is an aggressive, destructive asphalt mixture test that represents a worse-case scenario for an asphalt pavement regarding material degradation and thereby release of particulates. The results show that the mixture without the additive had a net increase of 600 particles/L while the mixture with the additive had a net increase of 100 particles/L. The hybrid additive significantly reduces the total number of particles of microplastics even though the number of plastic particles in the hybrid polymer asphalt mixture increased. Field data from an EPA-monitored state park in Pennsylvania, which measured microplastics runoff quarterly for two years, found 0% microplastics runoff during the measurement period, i.e., 100% containment of the microplastics during that time period.

TABLE 1

| | | Gₘₘ | | | | |
|---|---|---|---|---|---|---|
| | G_{sb} | Maximum | P_{b} | Gₛₑ | V_{ba}/V_{b} (%) | |
| | Aggregate | Asphalt | Percent of | Aggregate | Percentage | Percentage of |
| Hybrid | Bulk | Mixture | Binder | Effective | of Absorbed | Absorbed Binder |
| Polymer | Specific | Specific | (by weight of | Specific | Binder/ | (by weight of total |
| Additive | Gravity | Gravity | total mix) | Gravity | Total Binder | mix) |
| 0% | 2.656 | 2.493 | 4.8 | 2.685 | 8.2 | 0.39 |
| 2% | 2.656 | 2.479 | 4.8 | 2.668 | 3.3 | 0.16 |

Note:
G_{sb}, Gₘₘ, and P_{b} are measured values. The remaining values are calculated using these three values.

Results of the absorption of asphalt binder into an aggregate for an asphalt mixture with and without the hybrid additive are shown in Table 1. Asphalt that is absorbed into the aggregate is not available on the surface to perform many of the desirable properties of asphalt mixtures including increased strength, rutting resistance, cracking resistance, and waterproofing. Furthermore, the absorption of binder into an aggregate decreases the economics of an asphalt mixture. If an aggregate has a high absorption (>1.5%), then potentially up to 30% of the asphalt is absorbed into the aggregate. To achieve the same performance as a mix with no absorption of the effective binder content, the amount of binder equivalent to the absorbed binder has to be added to the mixture, which negatively affects the economics of the mixture.

Research has shown that binder can be selectively absorbed into an aggregate, which means the softer and more flexible components of the asphalt binder can be absorbed while leaving the harder, more brittle, and aging-prone components on the surface of the aggregate, which results in poor performance of the mixture (SHRP-A/UIR-90-009 Report, 1990). In general, it is desirable to have less asphalt absorbed into the aggregate for performance and economic reasons. Results shown in Table 1 demonstrate that the presently disclosed hybrid additive can reduce the absorption of binder in the aggregate from 8% to 3% of the total binder when included at 2% by weight of the total asphalt binder. This reduction in absorbed binder is equivalent to increasing the asphalt content (% AC) by approximately 0.2%, which is significant. The increased effective asphalt content is equal to approximately $1.00/mix ton (estimated based on 2021 pricing), which is also significant in the economically sensitive environment of low-cost bidding.

### Example 2: Hybrid Concrete Composites Comprising the Hybrid Additive

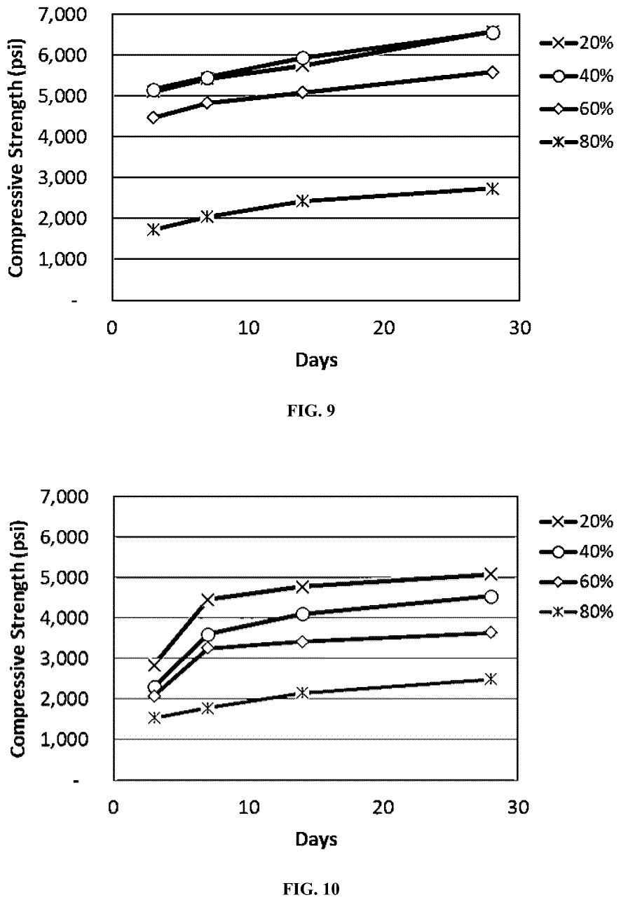

A hybrid concrete composite was formed comprising varied amounts of the hybrid additive disclosed herein. In FIG. 9, the compressive strength results for a hybrid composite formed with a Portland cement binder and different quantities of hybrid additive as aggregate replacement are shown. The quantities (volumes) of cement and water did not change during this testing. The aggregates were replaced by hybrid additive at different amounts (% of total volume of aggregates) such that the total aggregate/hybrid additive remained constant (i.e., mimicking an unchanged amount of aggregate).

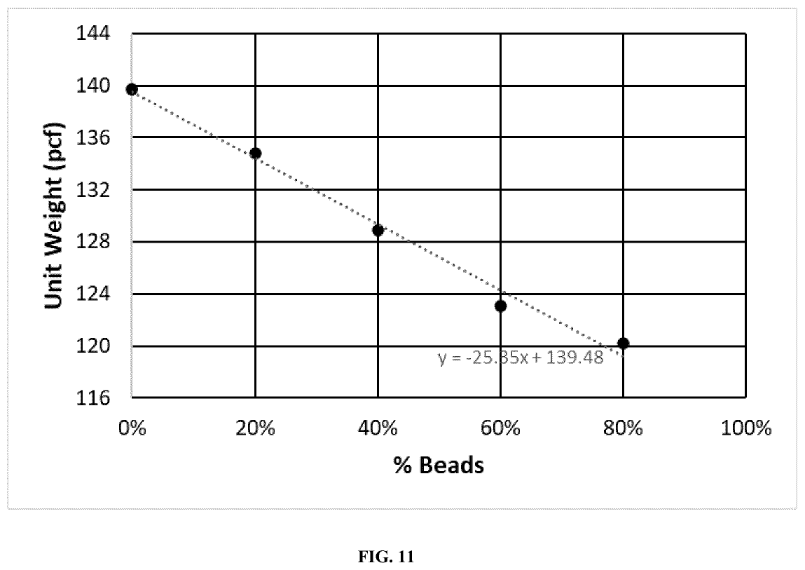

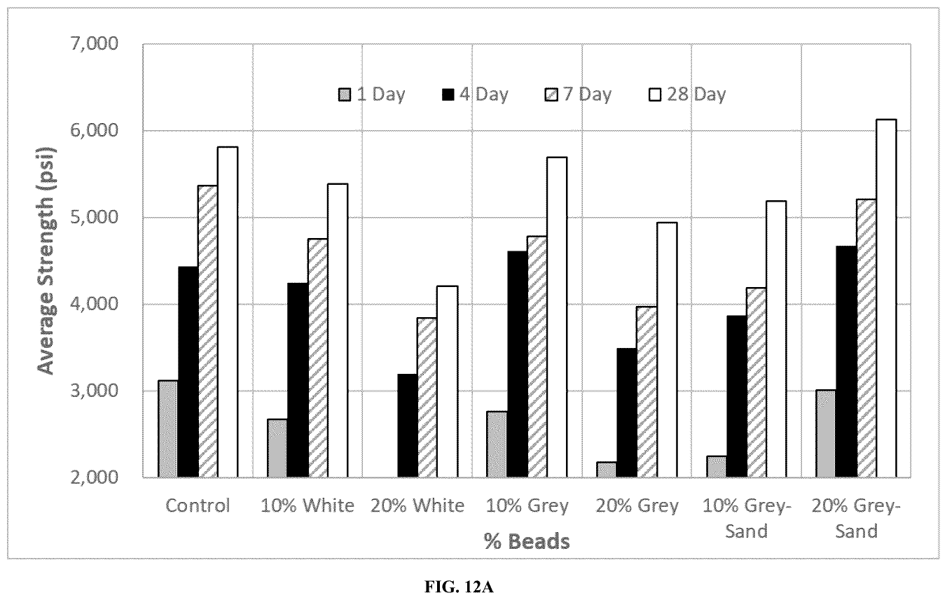

The results in FIG. 9 show that the hybrid additive provides a strong structure for the cement matrix to develop high strength, i.e., greater than 6,000 psi at 28 days, which is classified as high-strength concrete. The strength was high for 20% and 40% replacement by volume of all aggregates (sand and rock). A slight decrease in strength occurred at 60% replacement. At 80%, the strength was reduced to approximately 3,000 psi at 28 days, which is still acceptable strength for many applications such as sidewalks, wall panels, and cement blocks. Since the structural polymers have a lower density than aggregates, the overall density of the concrete decreases as the % volume of hybrid additive increases. Lighter concrete has many applications such as floors in buildings, wall panels, concrete blocks, and geotechnical applications. The reduction in weight, i.e., pounds per cubic foot (pcf), for the hybrid composites having various amounts of the aggregate replaced with hybrid additive is shown in FIG. 11 (e.g., same hybrid composites shown in FIG. 9).

In FIG. 10, the compressive strength results for a hybrid concrete composite comprising a Portland cement binder and varied amounts of the hybrid additive as aggregate replacement are shown. The difference between FIGS. 9 and 10 is the quantity of cement was reduced from 590 pounds to 540 pounds per cubic yard of concrete. This reduction in cement makes the construction composite material more economical and sustainable due to the use of less Portland cement and more recycled structural polymers. The results show that the structural polymers provide a strong structure for the cement matrix to develop high strength even with a reduced quantity of cement. The strength for 20% and 40% replacement was greater than 4,000 psi, which is a common strength requirement for Portland cement concrete. The mixtures in these tests developed most of their ultimate 28-day strengths by 7 days, which is desirable in tight construction schedules.

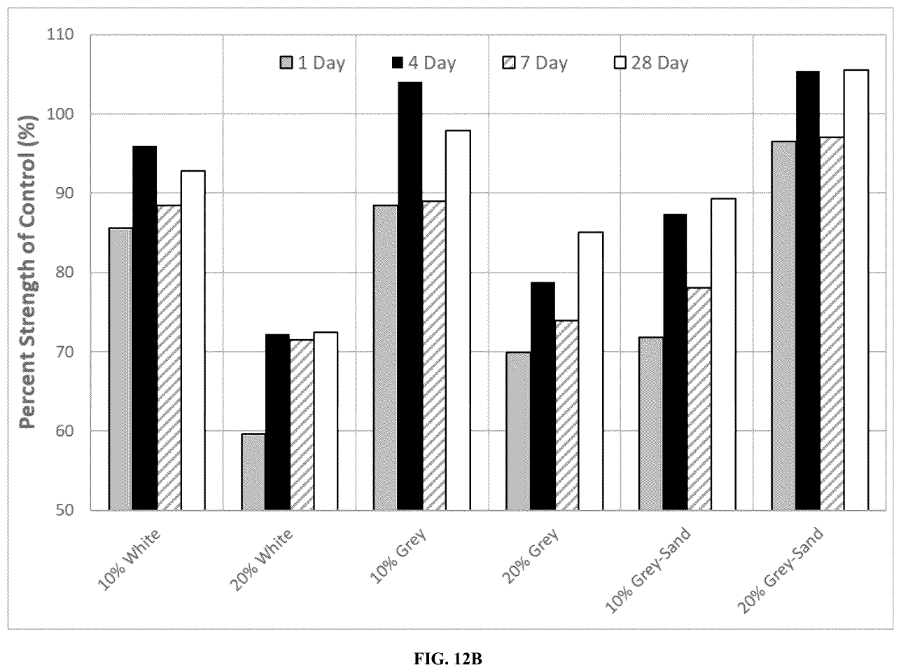

In FIGS. 12A and 12B, the compressive strength results for a hybrid concrete composite comprising a Portland cement binder and different quantities and types of hybrid additive as aggregate replacement are shown. The different types of hybrid additives are labeled as grey and white. The percentage listed in the labels is the percent (by weight) of the aggregate replaced by the hybrid additives. For the samples labeled “grey sand,” only the sand portion of the aggregate (approximately half of the total aggregate) was replaced.

The results in FIG. 12A shown the measured compressive strengths for the different mixtures for 1-, 4-, 7-, and 28-day strengths. In FIG. 12B, the percentage of strength of the control mixture for a given day is shown. FIG. 12B shows that the strength of the mixtures increases at similar rates to the control mixture. The 28-day strengths for 10% Grey (all aggregate) and 20% Grey Sand are very similar strengths to the control mix.

Results of chemical and mechanical wearing tests of expanded hybrid additives used in hybrid concrete composites are shown in Table 2. The results show that the hybrid additives prevent common issues in aggregates used in PCC due to exposure to different mineral salts, magnesium chloride and sodium chloride. The results show that the percent loss is less than 1.0%, which is well below the specification of less than 15% loss for both magnesium and sodium sulfate testing. The hybrid additives replace the aggregates and prevent the adverse reactions that occur between the mineral salts and the aggregates.

Furthermore, the hybrid additives are resilient, which is shown by the Los Angeles Abrasion test results in Table 2. The L.A. Abrasion test is an aggressive test to measure aggregate durability to abrasion of steel balls mixed with the aggregate in a container, i.e., a rotating steel drum steel fitted with an internal shelf that lifts and drops the steel balls and sample with each revolution, generating impact forces. The results show the % wear, which is a percentage of the material worn away, is approximately 1%, which is much less than the limit of 40% loss for typical aggregates.

TABLE 2

| | Magnesium Sulfate | Sodium Sulfate | L.A. Abrasion |
|---|---|---|---|
| Sample ID | Percent Loss, % | Percent Loss, % | Percent Wear, % |
| 15 | 0.1 | 0.8 | 1.1 |
| 13 | 0.2 | 0.6 | 1.1 |
| 08 | 0.2 | 0.5 | 1.3 |
| 07 | 0.1 | 0.5 | 1.2 |
| Specification | <15.0% Loss | <10.0% Loss | <40.0% Loss |

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments.

It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

What is claimed is:

1. A hybrid additive for use in construction materials, the hybrid additive comprising:
95 wt. % to 99.9 wt. % of a plastic or polymeric material; and
0.1 wt. % to 5 wt. % of an additional material, wherein the additional material comprises one or more of fibers, pozzolans, nano-carbon tubes, glass, recycled asphalt shingles (RAS), liquid anti-strip, hydrated lime, calcium carbonate, graphene, rejuvenators, cementitious material, and ground tire rubber,
wherein the additional material is stably incorporated with the plastic or polymeric material.

2. The hybrid additive of claim 1, having a shape comprising one or more vertices and a diameter of from 2 mm to 75 mm.

3. The hybrid additive of claim 2, coated with a cementitious material that includes one or more of calcium carbonate, graphene, hydrated lime, and pozzolanic materials.

4. The hybrid additive of claim 1, having a shape comprising one or more vertices and a diameter of from 0.02 mm to 2 mm.

5. The hybrid additive of claim 4, coated with a cementitious material that includes one or more of calcium carbonate, graphene, hydrated lime, and pozzolanic materials.

6. The hybrid additive of claim 1, having a cylindrical shape with a diameter of 1.0 mm to 13 mm and a length of 3 to 13 mm, and an end curvature at one or both ends of 1° to 30° measured as a total deflection from a longitudinal axis thereof.

7. The additive of claim 6, wherein the cylindrical shape comprises dimples, indentations, or inclusions on a surface that contain a cementitious material that includes one or more of calcium carbonate, graphene, hydrated lime, and pozzolanic materials.

8. The hybrid additive of claim 1, having a substantially spherical shape with a nominal diameter of 1.0 mm to 20 mm.

9. The additive of claim 8, wherein the substantially spherical shape comprises dimples, indentations, or inclusions on a surface that contain a cementitious material that includes one or more of calcium carbonate, graphene, hydrated lime, and pozzolanic materials.

10. The hybrid additive of claim 1, wherein the plastic or polymeric material is in a gas-expanded form.

11. The hybrid additive of claim 1, wherein the plastic or polymeric material comprise a melting temperature of 95° C. to 140° C.

12. The hybrid additive of claim 1, coated with a cementitious material that includes one or more of calcium carbonate, graphene, hydrated lime, and pozzolanic materials.

13. A hybrid construction material comprising:
0.5 wt. % to 15 wt. % of an asphalt binder;
0.1 to 10 wt. % of the hybrid additive according to claim 1; and
an aggregate,
wherein the wt. % is based on a total weight of the hybrid construction material.

14. The hybrid construction material of claim 13, wherein the aggregate and the hybrid additive are provided at 85 wt. % to 99.5 wt. % based on a total weight of the hybrid construction material, and wherein the hybrid additive is provided at 2 wt. % to 4 wt. %.

15. A paving structure comprising a cured hybrid construction material according to claim 13.

16. A method for forming the paving structure according to claim 15, the method comprising:
heating aggregate to a temperature of 105 C to 400° C.;
lowering the temperature of the aggregate to below 175° C.;
dry mixing hybrid additive with the aggregate to form a dry mix;
adding the dry mix to heated asphalt binder to form a hybrid construction material; and
compacting the hybrid construction material at 85° C. to 175° C. to form the flexible paving structure.

17. A hybrid construction material comprising:
0.5 wt. % to 30 wt. % of a cementitious binder;
10 to 60 wt. % of the hybrid additive according to claim 1; and
an aggregate,
wherein the wt. % is based on a total weight of the hybrid construction material.

18. The hybrid construction material of claim 17, wherein the aggregate and the hybrid additive are provided at 70 wt. % to 99.5 wt. % based on a total weight of the hybrid construction material, and wherein the hybrid additive is provided at 10 wt. % to 40 wt. %.

19. A cementitious structure comprising a cured hybrid construction material according to claim 17.

20. A method for forming the cementitious structure according to claim 19, the method comprising:
dry mixing the cementitious binder, aggregate, and hybrid additive of the hybrid construction material at ambient conditions to form a dry mix;
adding sufficient water to the dry mix to form a cementitious slurry that cures to form the cementitious structure.
